(19) United States
(12) Patent Application Publication
(10) Pub. No.: US 2007/0179868 A1
(43) Pub. Date: Aug. 2, 2007

(54) Electronic damaged vehicle estimating system that downloads part price data

(76) Inventor: William W. Bozym, Walnut Creek, CA (US)

Correspondence Address: IRELL & MANELLA LLP, 840 NEWPORT CENTER DRIVE, SUITE 400, NEWPORT BEACH, CA, 92660, US

(21) Appl. No.: 11/334,064

(22) Filed: Jan. 17, 2006

(51) Int. Cl. G06Q 30/00

(52) U.S. Cl. 705/27

(57) ABSTRACT

A system for generating electronic cost repair estimates for damaged vehicles. The system includes one or more client computers connected to a server through a network. The server maintains a database of current vehicle part prices. The current vehicle part prices are downloaded to the client computers through the network. The vehicle part prices are used to generate a repair cost estimate.

### BACKGROUND OF THE INVENTION

1. Field of the Invention

The subject matter disclosed generally relates to a method and system for generating a repair cost estimate for a damaged vehicle.

2. Background Information

When a vehicle such as an automobile is damaged the owner may file a claim with an insurance carrier. The vehicle is inspected to determine the amount of damage and the costs required to repair the automobile. The owner of the vehicle or the vehicle repair facility may receive a check equal to the estimated cost of the repairs. If the repair costs exceed the value of the automobile, or a percentage of the car value, the adjuster may “total” the vehicle. The owner may then receive a check equal to the value of the automobile.

The repair costs and other information may be entered by the adjuster into an estimate report. After inspection the adjuster sends the estimate report to a home office for approval. To improve the efficiency of the claims process there have been developed computer systems and accompanying software that automate the estimate process. By way of example, the assignee of the present invention, ADP Claims Services Group, Inc, (“ADP”) provides a software product under the trademark SHOPLINK that allows a claims adjuster to enter estimate data. The SHOPLINK product has a client side software platform that is loaded into the computer of a client such as a body shop. The client based software interfaces with a home office computer system. The home office computer system contains large databases that store claims records used to process insurance claims.

Estimating systems such as SHOPLINK provide the user with a series of graphical user interfaces that are used to perform the repair cost estimate. The interfaces may include a graphical display of vehicle parts that can be selected by the adjuster for repair. The system automatically associates a vehicle part price with the selected part. The selected parts and associated part prices may be listed on the graphical user interface.

The SHOPLINK estimating system is capable of providing estimates for numerous vehicles. Each vehicle has a large number of parts. Additionally, the estimating system may provide different prices for different part sources. For example, part prices for aftermarket, salvage or OEM sources of parts may be provided on the interface. Consequently, the SHOPLINK database contains a relatively large amount of data.

Estimating systems and data are provided to the remote computer on a portable storage medium such as a CD or DVD disks. Subsequent revisions of the vehicle part prices are stored onto disks and shipped to the remote computers on a periodic basis, sometimes every month. Storing and shipping disks to remote computer locations is a time consuming process that produces a lag in distributing price updates. This lag can result in outdated price information in an estimate. When a price(s) is outdated, the repair shop must supplement the estimate. Having to supplement an estimate, decreases the efficiency of the process. It would be desirable to provide an electronic vehicle estimating system that could update vehicle part prices without shipping disks.

### BRIEF SUMMARY OF THE INVENTION

A method and system for generating an electronic repair cost estimate for a damaged vehicle. The system includes a client computer that provides a plurality of graphical user interfaces that are used to generate the repair cost estimate with vehicle part prices. The vehicle part prices are update with part prices downloaded from a server through a network.

### BRIEF DESCRIPTION OF THE DRAWINGS

FIGS. 1 is a schematic of a network system that can be used to generate a repair cost estimate report through a network;

FIG. 2 is a schematic of a computer of the system;

FIG. 3 is a graphical user interface used to enter and/or select damaged parts of a vehicle;

FIG. 4 is a graphical user interface that provides a running cost total for the damaged vehicle;

FIG. 5 is a graphical user interface used to manually download price data;

FIG. 6 is an illustration of a database array;

FIG. 7 is an illustration of data transmitted from a server to client computers of the system;

FIG. 8 is a graphical user interface used to schedule periodic downloads of price data;

FIG. 9 is a message that is displayed on a graphical user interface when price data has been downloaded;

FIG. 10 is a graphical user interface that allows a user to restart a program to use downloaded price data;

FIG. 11 is a graphical user interface that provides the date of the last price data update.

### DETAILED DESCRIPTION

Disclosed is a system for generating electronic cost repair estimates for damaged vehicles. The system includes one or more client computers connected to a server through a network. The server maintains a database of current vehicle part prices. The current vehicle part prices are downloaded to the client computers through the network. The vehicle part prices are used to generate a repair cost estimate.

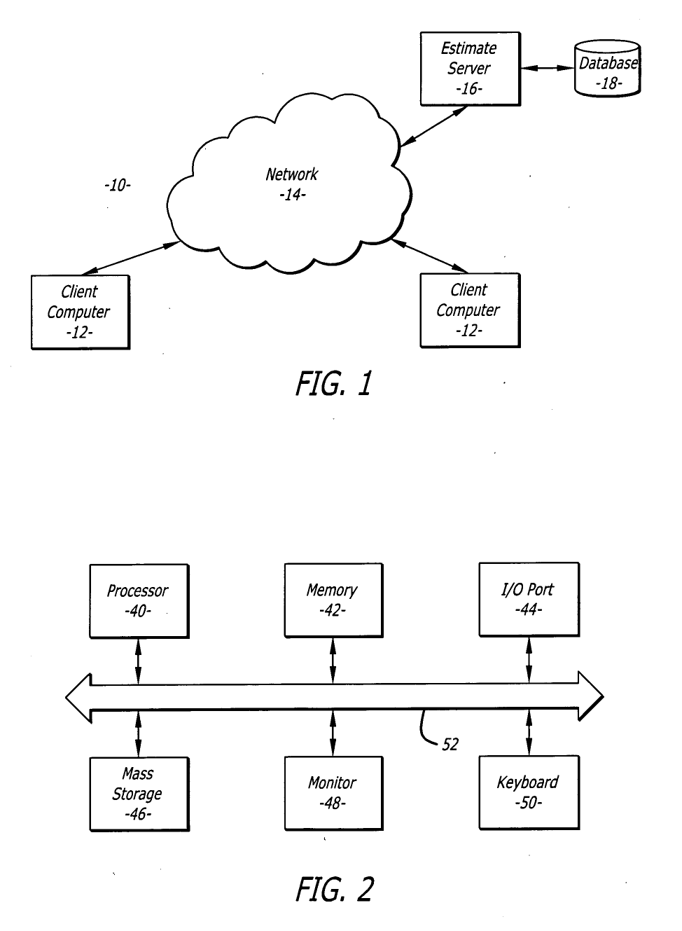

Referring to the drawings more particularly by reference numbers, FIG. 1 shows a system 10 that can be used to generate a repair cost estimate for an insurance claim of a damaged vehicle. The system 10 includes at least one client computer 12 that is connected to an electronic communication network 14. The electronic communication network 14 may be a wide area network (WAN) such as the Internet. Accordingly, communication may be transmitted through the network 14 in TCP/IP format.

The system 10 may further include an estimate server 16 connected to the network 14. The estimate server 16 may provide a portal for part price data and other information. The estimate server may be a web based portal that provides a plurality of web pages that can be used by the user of the client computer 12 to generate a repair cost estimate. By way of example, the user may be a claims adjuster that utilizes the web pages to determine the estimate of a damaged vehicle. Although one estimate server 16 is shown, it is to be understood that the estimate server may include two or more separate servers including a web server and an application server that together perform the estimate functions.

The server 16 may be connected to a database 18. The database 18 contains vehicle part prices for a variety of different vehicles. The database 18 may also contain prices for different sources of parts. For example, the database 18 may contain prices for OEM, after marker and/or salvage parts. Although a separate database is shown, it is to be understood that the server 16 may contain the database, and that there may be multiple linked servers.

FIG. 2 shows an embodiment of a computer 12. The computer 12 includes a processor 40 connected to one or more memory devices 42. The memory device 42 may include both volatile and non-volatile memory such as read only memory (ROM) or random access memory (RAM). The processor 40 is capable of operating software programs in accordance with instructions and data stored within the memory device 42.

The processor 40 may be coupled to a communication port 44, a mass storage device 46, a monitor 48 and a keyboard 50 through bus 52. The processor 40 may also be coupled to a computer mouse, a touch screen, a microphone, a speaker, an optical code reader (not shown). The communication port 44 may include an ETHERNET interface that allows data to be transmitted and received in TCP/IP format, although it is to be understood that there may be other types of communication ports. The system bus 52 may be a PCI or other conventional computer bus. The mass storage device 46 may include one or more disk drives such as magnetic or optical drives. The mass storage device 46 may also contain software that is operated by the processor 40.

Without limiting the scope of the invention, the term computer readable medium may include the memory device 42 and/or the mass storage device 46. The computer readable medium may contain software programs in binary form that can be read and interpreted by the computer. In addition to the memory device 42 and/or mass storage device 46, computer readable medium may also include a diskette, a compact disc, an integrated circuit, a cartridge, or even a remote communication of the software program. FIG. 2 may also represent the components of the server 16. In general the server 16 may contain more memory, additional communication ports and greater processing power than the computer 12.

The server 16 and/or database 18 may contain a relational database(s) that correlates data with individual data fields and a relational database management system (RDBMS). The RDBMS of the server 16 may include a reference to a website that can be accessed by the computers 12. Alternatively, the data may be organized in one or more files. The server 16 has a specific uniform resource locator (URL) that can be used to access the site through the network 14. The URL can be entered through a web-based application resident in the client computer 12. The client computer 12 may contain a program that is stored in mass storage 46 and/or memory 42 that provides a plurality of graphical user interfaces to a user viewing the monitor 48. The graphical user interfaces allow a user to perform an electronic repair cost estimates for a damaged vehicle. The program may be the same or similar to a product sold by ADP Claims Services Group, Inc. of San Ramon, Calif. under the trademark SHOPLINK.

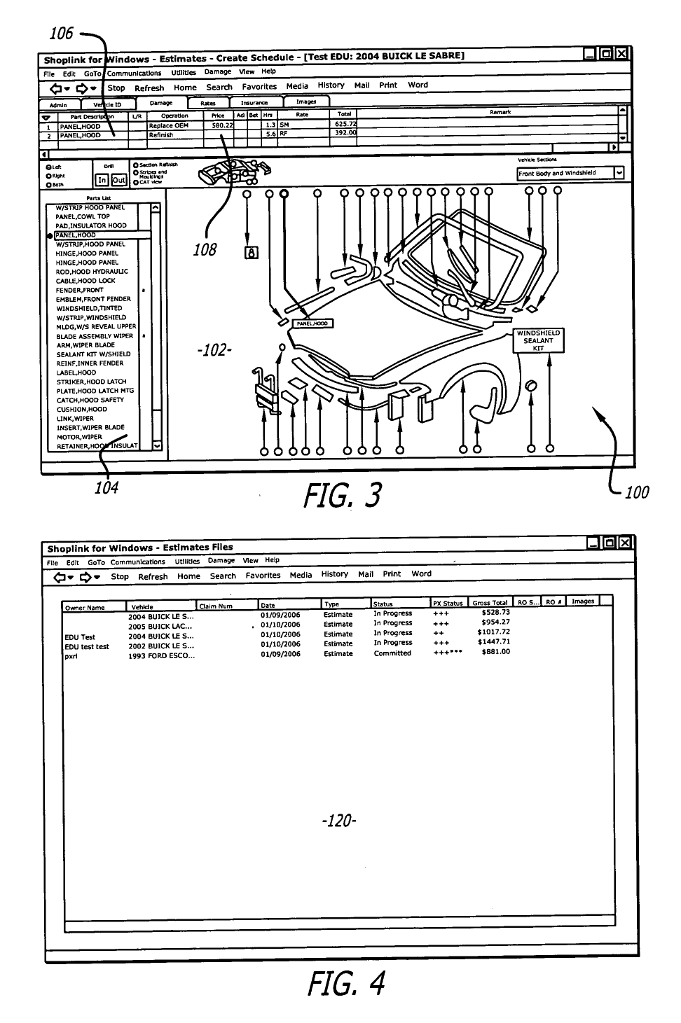

FIG. 3 shows an example of a graphical user interface 100 that allows a user to enter and/or select damaged parts of a vehicle. The interface 100 may include a graphical section 102 that can be selected by the user and a text section 104 that lists a plurality of selectable parts for the vehicle. The parts that are selected for replacement or repair can be listed in section 106. This section also contains a column 108 that shows the price of the part. The client computer contains a price part file or database that associates each part with a corresponding price. The program automatically fills in the column-108 when a part is selected by the user.

FIG. 4 shows a graphical user interface 120 that displays a running cost total of the estimated damage of the vehicle. The process may have a feature (not shown) that provides a warning to the user that the cost total exceeds a “totaled” value at which point the estimator discontinues the process and totals the vehicle. After all of the parts to be repaired or damaged are selected the adjuster may obtain a final estimate from the estimate page 120.

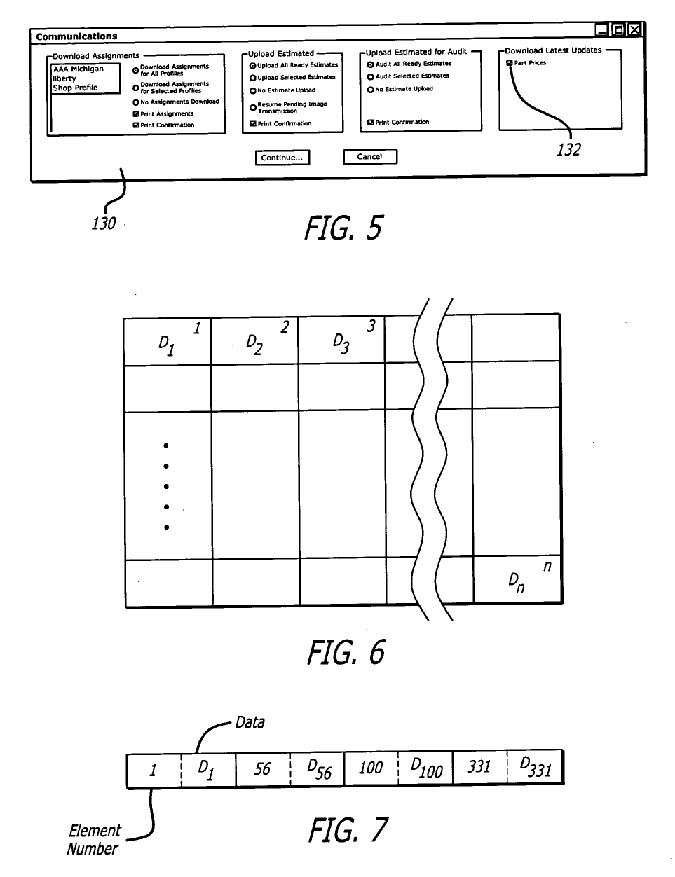

The program operating in the client computer 12 may obtain revised vehicle part prices from the server 16 through the network. By way of example, the user can initiate a “manual,, download of the revised vehicle part prices through the graphical user interface 130 shown in FIG. 5. The interface 130 may have a PART PRICES option window 132 that can be selected to initiate the download of the revised part prices. The client computer communicates with the server to request a download of updated price information. The server 16 then provides the vehicle part prices to the client 12.

The server 16 may provide the entire database of part price data to the client computer. Alternatively, the server may only provide data for parts that have changed in price since the last update. By way of example, the price data may be initially loaded into the client computer through a portable storage medium such as a CD. The initial loading of data may have occurred in July. The client computer may request price data from the server in September. The server may have a program that determines which parts changed prices from July to the date of the request and then only download those parts with different prices. The July date is provided by the client computer, preferably during the initial request to the server. The server downloads a delta file that contains part prices only for those parts which have changed price since the July CD date. The client computer may contain a translation table that translate the delta file data into the appropriate locations of the client computer part price database. The program may also prevent the updating of data with old data. For example, if the data is downloaded in September and an August CD is loaded into the computer, the program may check the date of the CD and ignore data that corresponds to data downloaded in September.

An example of the delta file concept can be shown with FIGS. 6 and 7. FIG. 6 is a two-dimensional array of data elements. Each element contains data D₁ on the vehicle part number and the price of the part. Each element is identified by an identifier 1→n. Both the server and the client computer may have the same array. Instead of downloading the entire array, the server may only transmit elements that contain new price information as shown in FIG. 7. The transmitted information includes the number of the element in the array and the data associated with each elements. The client computer then updates the same elements in the client computer file or database.

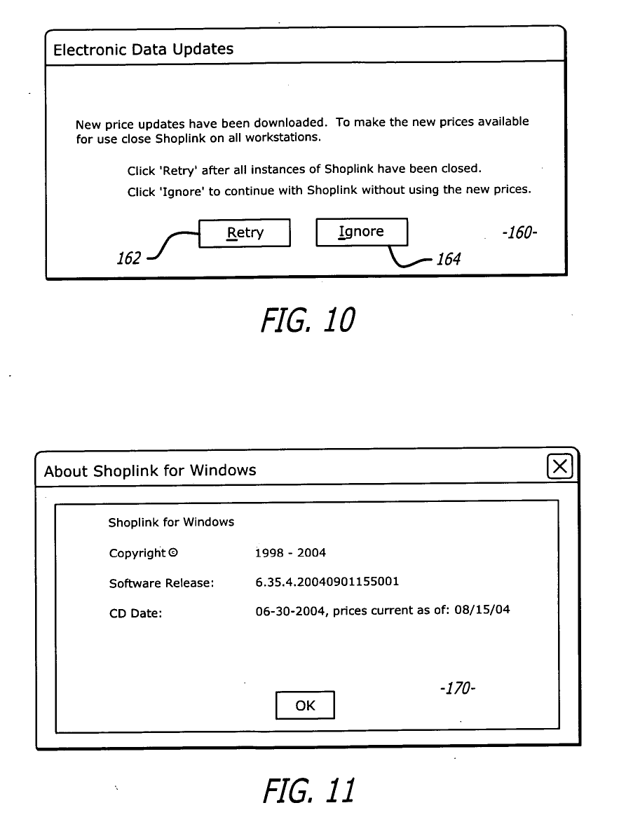

When the price data has been downloaded into the client computer the graphical user interface being viewed by the user may display a message 150 as shown in FIG. 9. The data can be used by restarting the program. Restarting the program may cause the display of the graphical user interface 160 shown in FIG. 10. The interface 160 provides the user with the option of resending the data to other computers in the network by selecting the RETRY button 162 or ignoring the download by selecting the IGNORE button 164. The user can use the downloaded price data if all of the computers in a group of computers have received the data and restarted the program. The client computer program may automatically restart the program if the user attempts to use price data. The client computer program may display a status graphical user interface 170 as shown in FIG. 9 that shows the date of the most recent price data update.

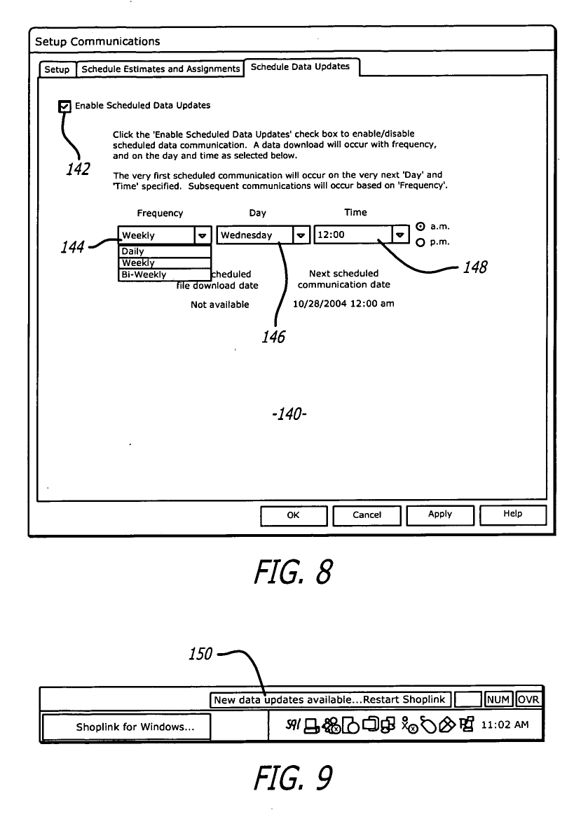

FIG. 8 shows a graphical use interface 140 that can be used to schedule periodic downloads of the price data from the server. The interface 140 may have an ENABLE window 142 that can be selected to enable the automatic download function. The interface 140 may also have a FREQUENCY field 144 that allows the user to select the frequency of the downloads. The user may also select a day and time for the downloads through DAY 146 and TIME 148 fields, respectively.

If the client computer is part of a group of computers, then the program may prevent usage of the new price data until every computer in the group has restarted the program. This insures that everyone in the group is using the same data. Upon receiving revised price data, a computer can query the other computers in the group to determine if every computer has restarted the program.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A system for generating a repair cost estimate for a damaged vehicle, the system being coupled to a network, comprising:
a server that is coupled to the network and contains a plurality of server vehicle part prices that are transmitted through the network; and,
a client computer that is coupled to the network, said client computer providing a plurality of graphical user interfaces to generate a repair cost estimate that includes a plurality of client computer vehicle part prices, said client computer updates said client computer vehicle part prices with said server vehicle part prices that are transmitted from said server through the network.

2. The system of claim 1, wherein said server vehicle part prices are transmitted in accordance with a predetermined schedule.

3. The system of claim 2, wherein said client computer provides a graphical user interface to select said schedule for transmitting said server vehicle part prices.

4. The system of claim 1, wherein said client computer provides a graphical user interface to restart said client computer to utilize said transmitted server vehicle part prices.

5. The system of claim 4, further comprising a plurality of client computers that each receive said server vehicle part prices, said client computers cannot utilize said server vehicle part prices until every client computer has restarted a program.

6. The system of claim 1, wherein said client computer provides a notice of a date when said client computer part prices were updated.

7. The system of claim 1, wherein a delta number of vehicle part prices have varied from a time said client computer requests a download to a time said client computer last updated said vehicle price parts, said server only downloads said delta vehicle part prices to said client computer.

8. A system for generating a repair cost estimate for a damaged vehicle, the system being coupled to a network, comprising:
a server that is coupled to the network and contains a plurality of server vehicle part prices that are transmitted through the network; and,
a client computer that is coupled to the network, said client computer having estimate means for providing a plurality of graphical user interfaces to generate a repair cost estimate that includes a plurality of client computer vehicle part prices and updating said client computer vehicle part prices with said server vehicle part prices that are transmitted from said server through the network.

9. The system of claim 8, wherein said server vehicle part prices are transmitted in accordance with a predetermined schedule.

10. The system of claim 9, wherein said estimate means provides a graphical user interface to select said schedule for transmitting said server vehicle part prices.

11. The system of claim 8, wherein said estimate means provides a graphical user interface to restart said client computer to utilize said transmitted server vehicle part prices.

12. The system of claim 11, further comprising a plurality of client computers that each receive said server vehicle part prices, said client computers cannot utilize said server vehicle part prices until every client computer has restarted a program.

13. The system of claim 8, wherein said estimate means provides a notice of a date when said client computer part prices were updated.

14. The system of claim 8, wherein a delta number of vehicle part prices have varied from a time said client computer requests a download to a time said client computer last updated said vehicle price parts, said server only downloads said delta vehicle part prices to said client computer.

15. A computer program storage medium that causes a client computer to provide graphical user interfaces for generating a repair cost estimate for a damaged vehicle, the system being coupled to server through a network, the server contains a plurality of server vehicle part prices, comprising:
a computer program storage medium that includes a program that causes a client computer to provide a plurality of graphical user interfaces to generate a repair cost estimate that includes a plurality of client computer vehicle part prices, and download the server vehicle part prices through the network to update said client computer vehicle part prices with said server vehicle part prices transmitted from the server through the network.

16. The storage medium of claim 15, wherein said program causes said server vehicle part prices to be transmitted in accordance with a predetermined schedule.

17. The storage medium of claim 16, wherein said program causes said client computer to provide a graphical user interface to select said schedule for transmitting said server vehicle part prices.

18. The storage medium of claim 15, wherein said program causes said client computer to provide a graphical user interface to restart said client computer to utilize said transmitted server vehicle part prices.

19. The storage medium of claim 18, further comprising a plurality of client computers that each receive said server vehicle part prices, said client computers cannot utilize said server vehicle part prices until every client computer has restarted a program.

20. The storage medium of claim 15, wherein said program causes said client computer to provide a notice of a date when said client computer part prices were updated.

21. The storage medium of claim 15, wherein a delta number of vehicle part prices have varied from a time said client computer requests a download to a time said client computer last updated said vehicle price parts, said server only downloads said delta vehicle part prices to said client computer.

22. A method for generating a repair cost estimate for a damaged vehicle, comprising:
transmitting a plurality of vehicle part prices from a server to a client computer through a network;
providing one or more graphical user interfaces to select at least one vehicle part at the client computer;
selecting a vehicle part from said graphical user interface; and,
displaying at least one of the transmitted vehicle part prices with the selected vehicle part at the client computer.

23. The method of claim 22, wherein the vehicle part price is transmitted in accordance with a predetermined schedule.

24. The method of claim 23, further comprising providing a graphical user interface to select the schedule for transmitting the vehicle part price.

25. The method of claim 22, wherein the client computer is restarted after receiving the vehicle part price.

26. The method of claim 25, wherein the vehicle part price is transmitted to a plurality of client computer which cannot utilize the downloaded vehicle part price until every client computer has restarted a program.

27. The method of claim 22, further comprising providing a graphical user interface with a notice of a date when the client computer part prices were updated.

28. The method of claim 22, further comprising updating the vehicle part prices at a first time, requesting an update of the vehicle part prices at a second time and transmitting only the vehicle part prices that have changed from the first time to the second time.
